(19) United States
(12) Patent Application Publication
(10) Pub. No.: US 2006/0002233 A1
(43) Pub. Date: Jan. 5, 2006

(54) Combination tool for aligning, measuring distances and sensing objects under a surface

(76) Inventor: Fabrice Malard, Boulogne (FR)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 10/506,849

(22) PCT Filed: Jul. 21, 2004
(86) PCT No.: PCT/EP04/09152

§ 371 Date: Jun. 22, 2005

(30) Foreign Application Priority Data
Mar. 9, 2003 (EP) 1 341 005

(51) Int. Cl. G01S 3/80

(52) U.S. Cl. 367/128

(57) ABSTRACT

A combination tool (20) includes a housing (22) and a laser device (32) rotatably mounted on the housing (22) for projecting a laser line used for aligning and for projecting a laser beam used for aiming, a sonic device (36) coupled with the housing (22) for measuring distances between the tool and a spaced object, a sensor coupled with the housing for sensing objects hidden behind a surface, and a bracket attachable to the housing, the bracket having a first position in which the housing is free to move over the surface and a second position in which the housing is secured in place over the surface.

The present invention is related to tools used in a construction environment and is more particularly related to electronic tools used for aligning, measuring distances and sensing objects under a surface.

There are many different tools used in the construction and home improvement industries. One well-known tool for measuring linear distances is a tape measure, which includes a housing and a flexible measuring tape, which may be drawn from the housing for measuring distances. Another well-known tool includes a bubble level for insuring that surfaces are level in horizontal and/or vertical planes. Yet another device is a T-Square, which is generally used for forming 90° angles between objects. Still further construction tools include sensors such as stud sensors, metal sensors and electric current sensors. Recently, there have been a number of advances in tools that combine one or more of the features listed above.

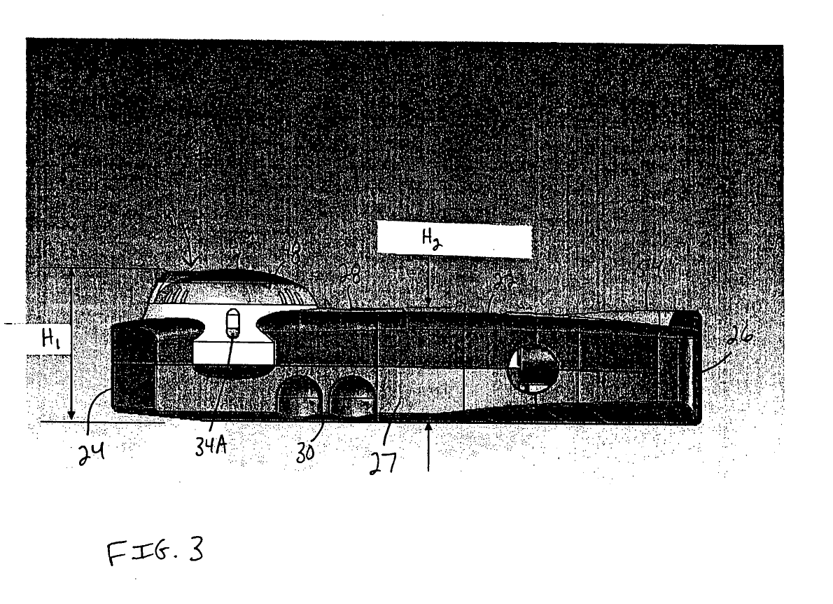

For example, U.S. Pat. No. 6,157,591 to Kranz discloses a sonic range finder with laser pointer. As shown in FIG. 2 thereof, the range finder 30 projects an acoustic beam 12 and a cone-shaped laser beam 34 of about the same size and direction as the acoustic beam 12. The laser pattern 36 also includes a central dot 38 that indicates the center of the acoustic beam.

U.S. Pat. No. 4,700,489 to Vasile discloses a combination tool including a tape measure, a bubble level, a stud locator and marker, and a square.

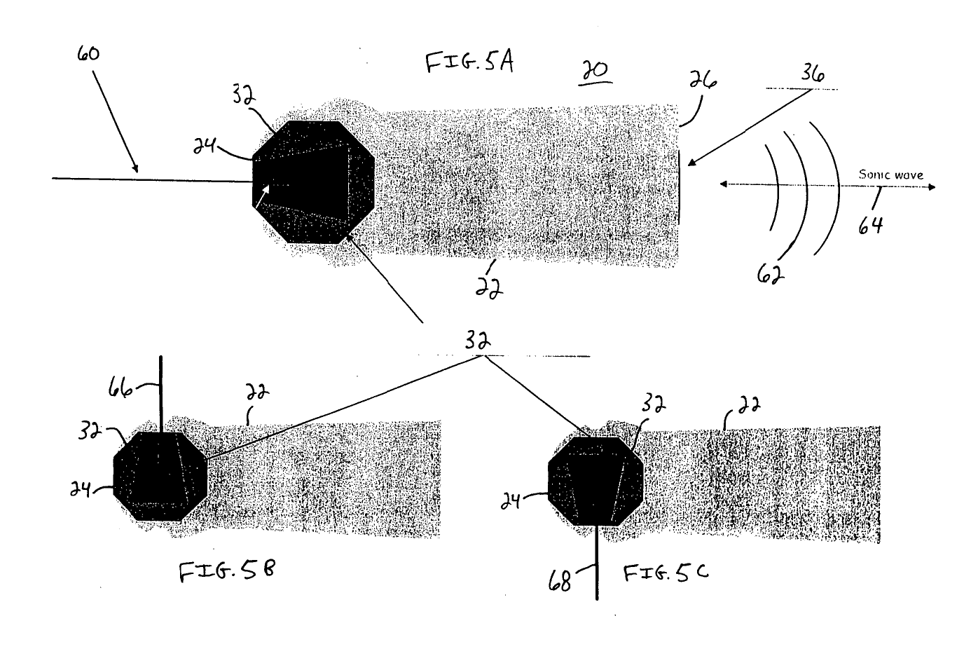

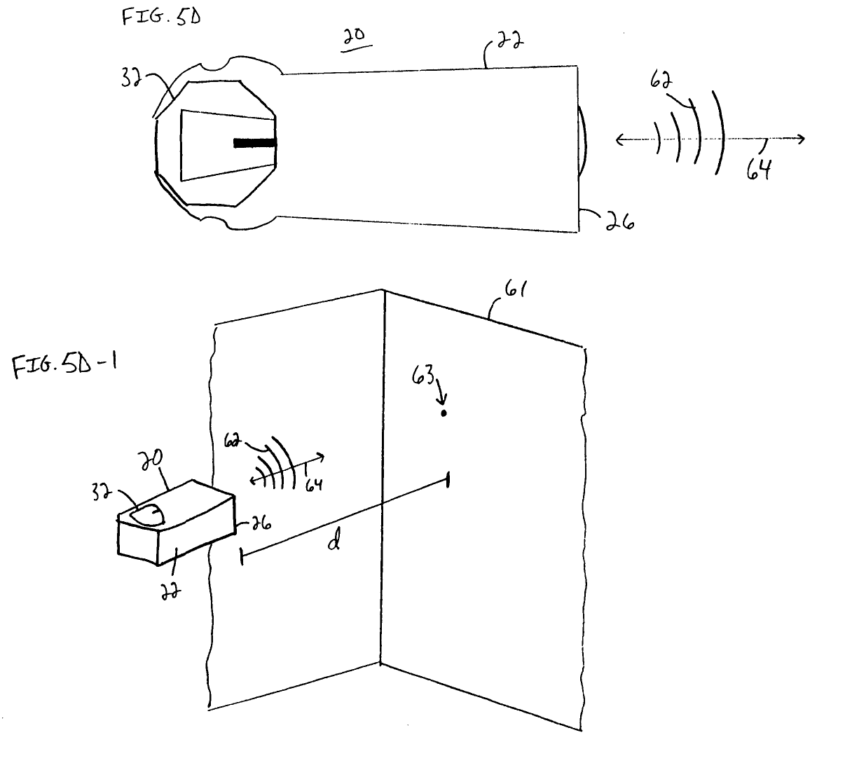

U.S. Pat. No. 6,402,319 to Goodrich et al. discloses an apparatus for producing a visible line of light on a surface. As shown in FIGS. 4 and 5 thereof, a laser diode 2 is positioned above a surface 4 to be marked, with the wide divergence angle of the laser perpendicular to the surface. Cylindrical lenses 6, 8 and 10 project a beam 11 from the laser diode 2 onto a continuous line 14. The widths of the lenses are chosen to collect all of the light from the narrow divergence angle of the diode. The use of a plurality of lenses in the direction of the wide divergence (long axis) allows most of the light to be collected, thereby enhancing the efficiency of the system. Focus adjustment for distance can be accomplished either by using different focal length lenses or by adjusting the distance from the diode to each lens.

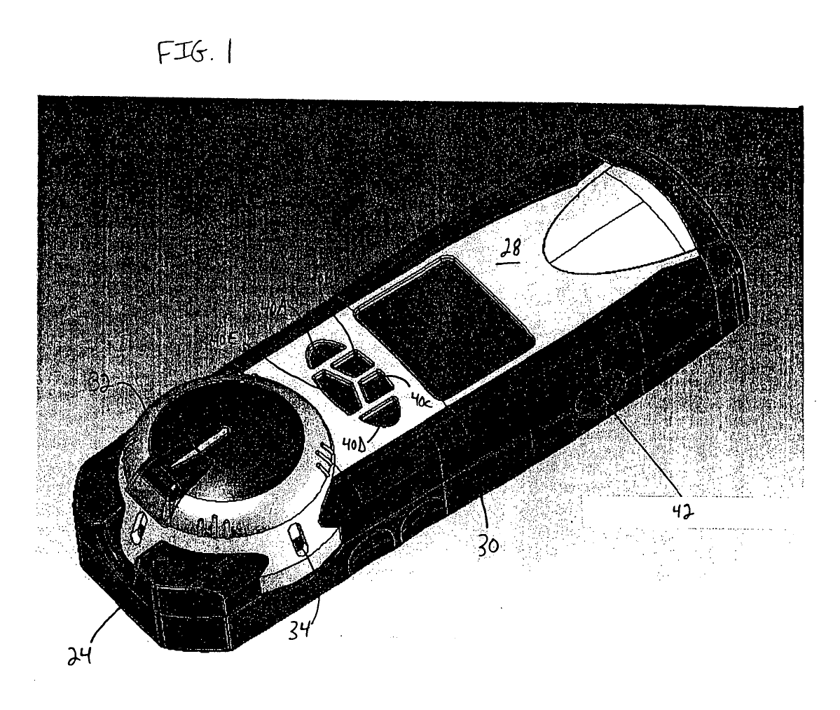

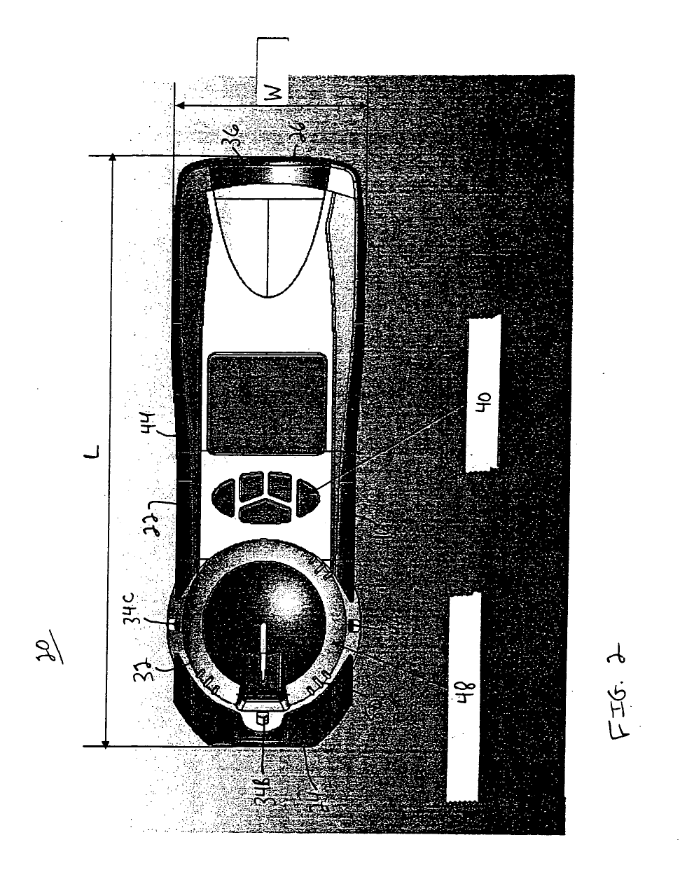

U.S. Pat. No. 6,606,798 to El-Katcha discloses a laser level. Referring to FIG. 1 thereof, the laser level 10 includes a frame assembly 30, an engine assembly 40 rotatably attached to the frame assembly 30, a laser diode assembly 41 disposed within engine assembly 40, a protective assembly 20 connected to frame assembly 30, a shoe assembly 50 slideably attached to protective assembly 20, a clamp assembly 80 disposed on shoe assembly 50 and a multi-battery adapter assembly 70 for receiving a battery 60.

U.S. Pat. No. 6,259,241 to Kranz discloses a hand-held detector unit that detects the presence of an object behind a surface and projects a visible pattern onto the surface behind which the sensed object is located. The projected pattern, such as a line, represents a characteristic of the detected object. Similarly, U.S. Patent Application Publication No. U.S. 2001/0007420 to Bijaw discloses a hidden object sensor that senses and locates hidden objects behind the surface of an architectural structure. The sensor includes a circuit for detecting the presence of live wires, metal objects and wood studs.

U.S. Pat. No. 5,894,675 to Cericola discloses a combination tool for use in measuring, leveling, squaring and plumbing operations. Referring to FIGS. 1-9 thereof, the combination tool 10 including a housing 12 adapted to encase a tape measure 2 having an extendable tape 3 and a laser source 5 capable of projecting a visible light beam 6. The extendable tape 3 and the visible light beam 6 extend in directions that are perpendicular to one another. The tool also includes a horizontal bubble-leveling vial 41 and a vertical bubble-leveling vial 42 mounted on the housing for leveling in horizontal and vertical planes.

U.S. Pat. No. 6,581,296 to Ponce discloses a tape measure with laser beam. Referring to FIG. 2 thereof, tape measure includes a case 12, a laser device 70 carried in the case that produces a laser beam 10 and a roll 24 of measuring tape 25 supported in the case.

In spite of the above advances, there remains a need for a tool that more efficiently combines multiple functions related to alignment, measuring distances and sensing objects under a surface. There also remains a need for a tool that makes it easier to perform such alignment, measuring and sensing functions.

In certain preferred embodiments of the present invention, a combination tool includes a housing, and a laser device rotatably mounted to the housing, whereby the laser device is rotatable to a first position for projecting a laser line and a second position for projecting a laser beam. The tool also desirably includes a sonic device connected to the housing and being adapted to project signals for measuring distances between the tool and a spaced object.

In certain preferred embodiments, the tool may include a microprocessor in communication with the laser device and the sonic device, whereby the microprocessor determines a first distance between the laser line and the surface when the laser device is in the first position and a second distance between a predetermined point on the housing and the surface when the laser device is in the second position. The predetermined point may be the first end of the housing. In other preferred embodiments, the predetermined point may be the second end of the housing or any point between the first and second ends of the housing.

The tool may also include an orientation element in communication with the microprocessor for determining whether the first end of the housing is above the second end of the housing in an upright orientation or the first end of the housing is below the second end of the housing in an inverted orientation. The orientation element may include one or more mercury switches in communication with the microprocessor. In certain preferred embodiments, the orientation element includes a pair of mercury switches.

The tool may also include a visual display in communication with the microprocessor, whereby the visual display presents data in a first direction when the housing is in the upright orientation and in a second direction when the housing is in the inverted orientation.

The tool may also include a bracket attached to the housing for supporting the tool over a surface, the bracket having a first mode in which the housing is free to move over the surface and a second mode in which the housing is secured in place over the surface. The bracket desirably has at least one anchoring element movable between a retracted position for enabling the housing to freely move over the surface and an extended position for securing the bracket to the surface. The at least one anchoring element preferably includes a pin having a pointed end adapted to engage the surface when the at least one anchoring element is in the extended position.

The tool may also include a sensor coupled with the housing for detecting objects hidden behind a surface. The hidden object sensor may be a wood stud sensor, an electrical current sensor for detecting live electrical wires and/or a metal sensor for detecting reinforcing bar in concrete or metal studs in walls.

The sonic device may be used to measure distances by sending sonic waves at an object and then detecting the rebounding waves. The sonic device preferably sends the waves along an axis. The sonic device may be located at an end of the housing. In certain preferred embodiments, when the laser beam is projected from said laser device, the sonic waves/signal projected from the sonic device extend in directions that are substantially co-axial with the laser beam.

The laser device desirably includes a laser and at least one optical element for diffracting light from the laser for projecting the laser line. The laser is optically coupled with the at least one optical element when the laser device is rotated to the first position. In certain preferred embodiments, the laser device includes a plurality of optical elements at various angles such as 90° left, 45° left, 30° left, 0°, 30° right, 45° right and 90° right. The optical element may be selected from the group consisting of a lens, a diffraction grating and a holographic element.

The tool may also include a sensor coupled with the housing for detecting objects hidden behind a surface. The sensor may be an electrical current sensing circuitry for detecting electrical wires, a metal sensing circuitry for sensing metal objects and a wood sensing circuit for sensing wood objects. The tool may also include one or more control buttons accessible at an outer surface of the housing for controlling operation of the tool, and a visual display provided on the housing for displaying measuring, aligning or sensing data.

In certain preferred embodiments, the tool includes a first leveling device for leveling the tool in a horizontal plane and a second leveling device for leveling the tool in a vertical plane. The laser device preferably includes a rotatable cover having a transparent portion, whereby the first and second leveling devices are visible through the transparent portion.

In another preferred embodiment of the present invention, a combination tool includes a housing, a laser device rotatably mounted on the housing, and a sonic device connected to the housing and being adapted to project sonic signals for measuring distances between the tool and a spaced object, whereby in a first rotated position the laser device is adapted to project a laser line and in a second rotated position the laser device is adapted to project a laser beam used for aiming the sonic device. The housing has a longitudinal axis and the laser device is preferably rotatable for projecting a plurality of laser lines at various angles relative to the longitudinal axis. The housing desirably has a first end and a second end and the sonic device is positioned at the second end, whereby the laser device is oriented toward the second end of the housing when in the second rotated position for aiming the sonic device. The tool may include a bracket attachable to the housing for selectively mounting the tool over a surface, the bracket having at least one anchoring element movable between a retracted position in which the tool is freely movable over the surface and an extended position in which the tool is anchored in place over the surface. The housing is desirably releasably attachable to the bracket. The bracket has one or more slots and the housing has one or more projections that are adapted to be snap-fit into the one or more slots.

In certain preferred embodiments, the tool may include a visual display, such as a LED or LCD screen, for displaying information related to operation of the tool. For example, the visual display may show a distance measured by the sonic device, an angle at which the rotatable laser device is set or the type of hidden object (e.g. live wire) sensed by the hidden object sensor. The tool may also include one or more keys or buttons for operating the tool. A first set of keys may be used for activating and deactivating the tool, and a second set of keys may be used for measuring distances, aligning, sensing, etc. The tool may also include a microprocessor coupled with the various devices such as the sonic distance measuring device, the visual display, the keys for controlling the tool, the sensing device for sensing hidden objects and the rotatable laser.

In yet another preferred embodiment of the present invention, a combination tool includes a housing, a laser device rotatably mounted on the housing, the laser device being rotatable to a plurality of first angles for projecting a laser line used for aligning and being rotatable to a second angle for projecting a laser beam used for aiming. The tool also desirably includes a sonic device coupled with the housing for measuring distances between the tool and a spaced object, a sensor coupled with the housing for sensing objects hidden behind a surface, and a bracket attachable to the housing, the bracket having a first position in which the housing is free to move over the surface and a second position in which the housing is secured in place over the surface. The bracket preferably has at least one anchoring element movable between a retracted position for enabling the housing to move freely over the surface and an extended position for securing the bracket to the surface. The bracket desirably has a safety cover slidable between a closed position when the at least one anchoring element is retracted and an open position when the at least one anchoring element is extended.

The invention will now be described by way of example with reference to the drawings, in which:

FIG. 1 shows a perspective view of a combination tool, in accordance with certain preferred embodiments of the present invention.

FIG. 2 shows a top plan view of the combination tool of FIG. 1.

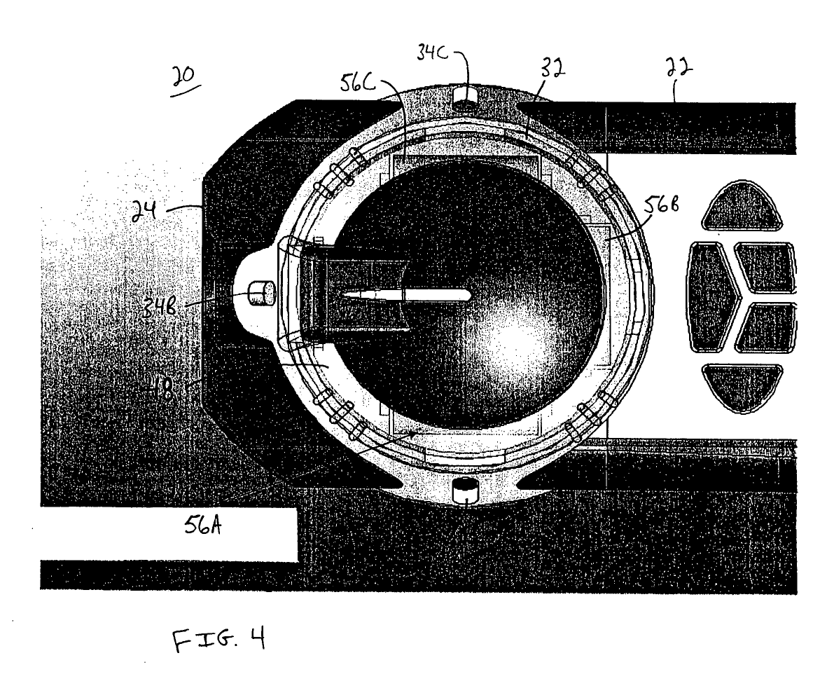

FIG. 3 shows a front elevational view of the combination tool of FIG. 1.

FIG. 4 shows an expanded view of a first end of the combination tool of FIG. 1.

FIGS. 5A-5D show the combination tool of FIG. 1 including a rotatable laser device.

FIG. 5D-1 shows a perspective view of the combination tool of FIG. 5D projecting a laser beam on a wall.

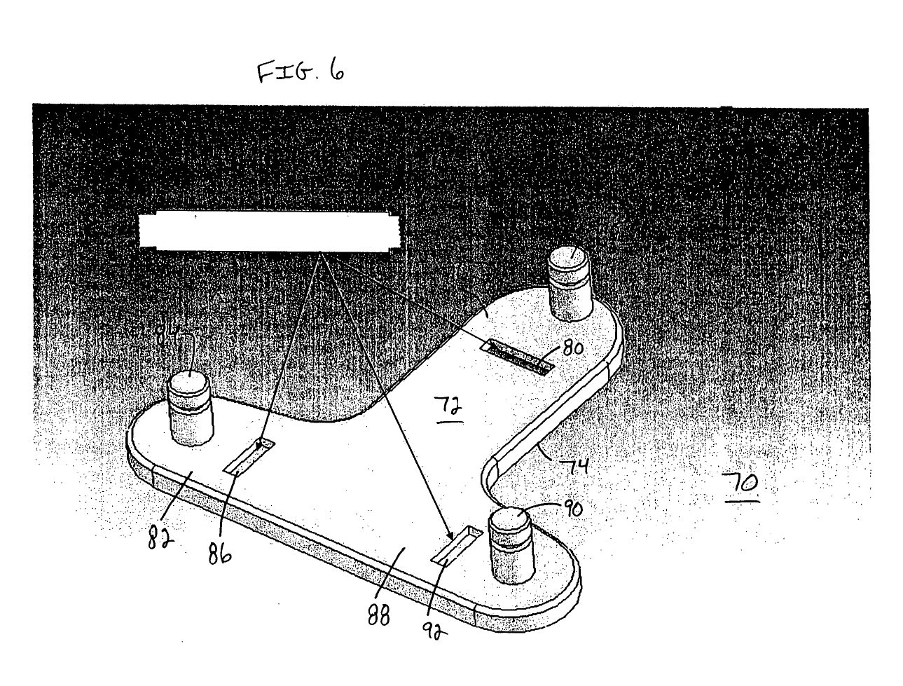

FIG. 6 shows a perspective view of a mounting bracket for the combination tool of FIG. 1, in accordance with certain preferred embodiments of the present invention.

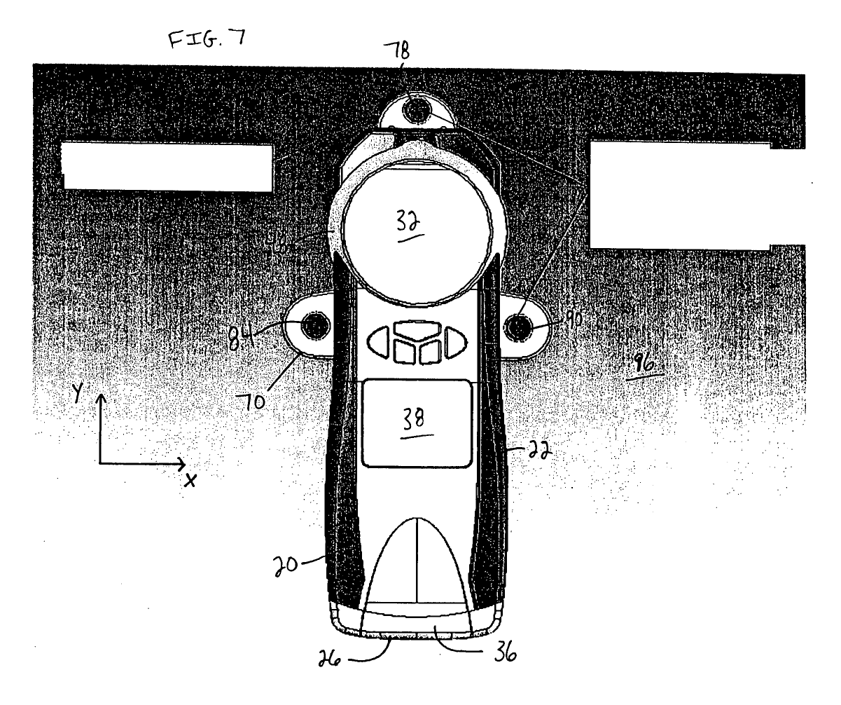

FIG. 7 shows the combination tool of FIG. 1 coupled with the mounting bracket of FIG. 6.

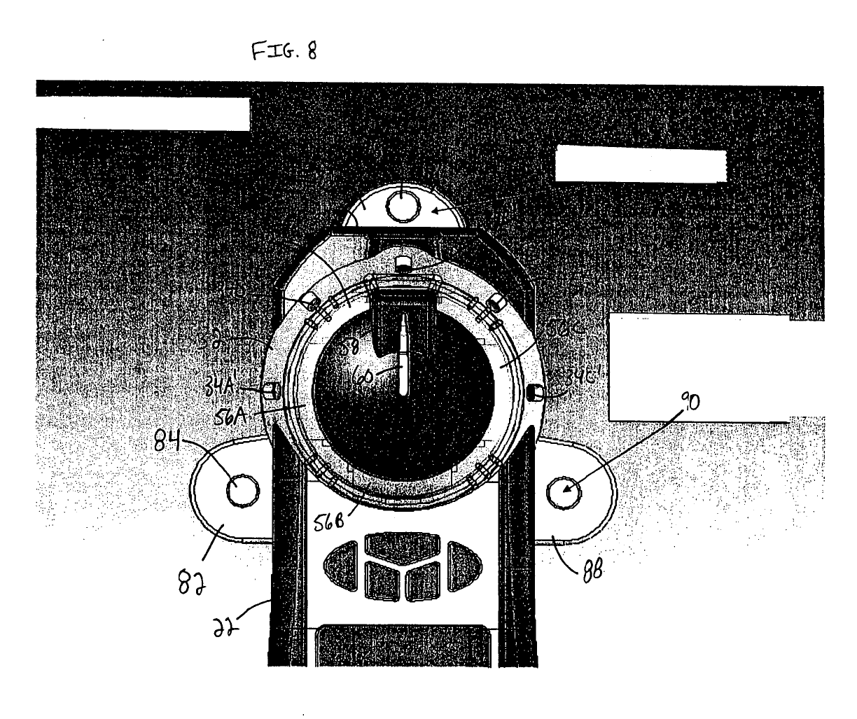

FIG. 8 shows an expanded view of the combination tool and mounting bracket of FIG. 7.

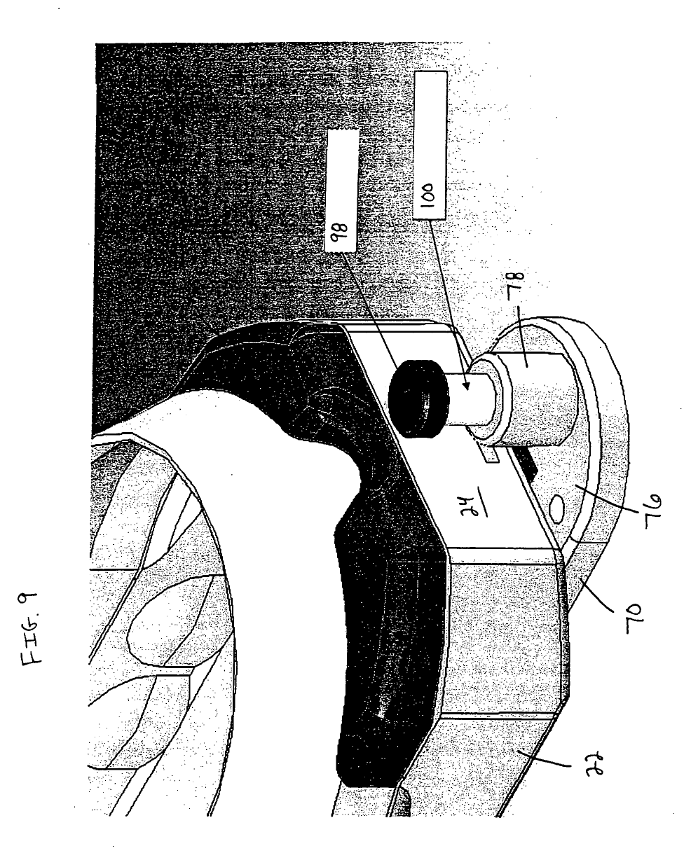

FIG. 9 shows a perspective view of one end of the mounting bracket and combination tool of FIGS. 7 and 8.

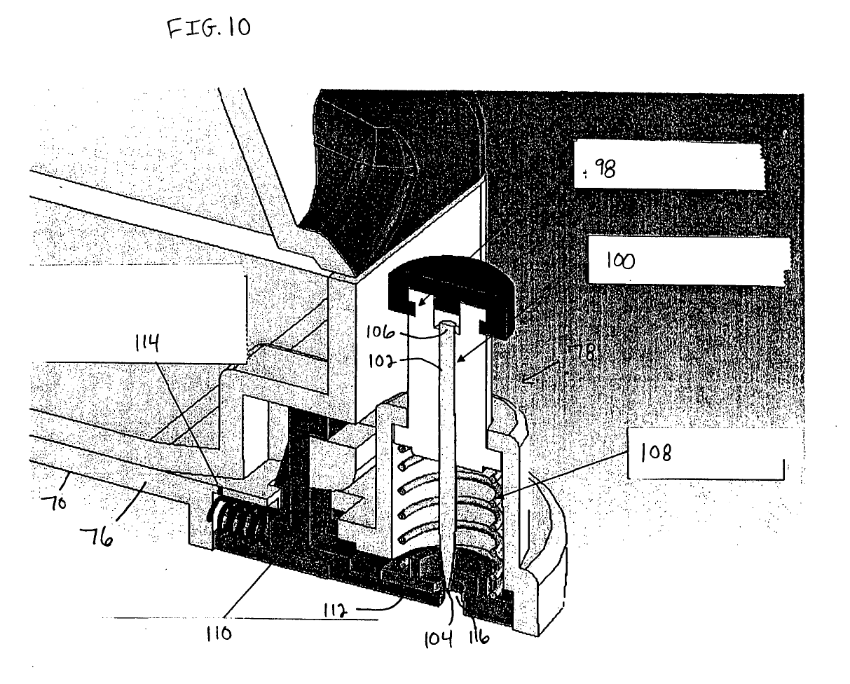

FIG. 10 shows a cross-sectional view of the mounting bracket and combination tool of FIG. 9.

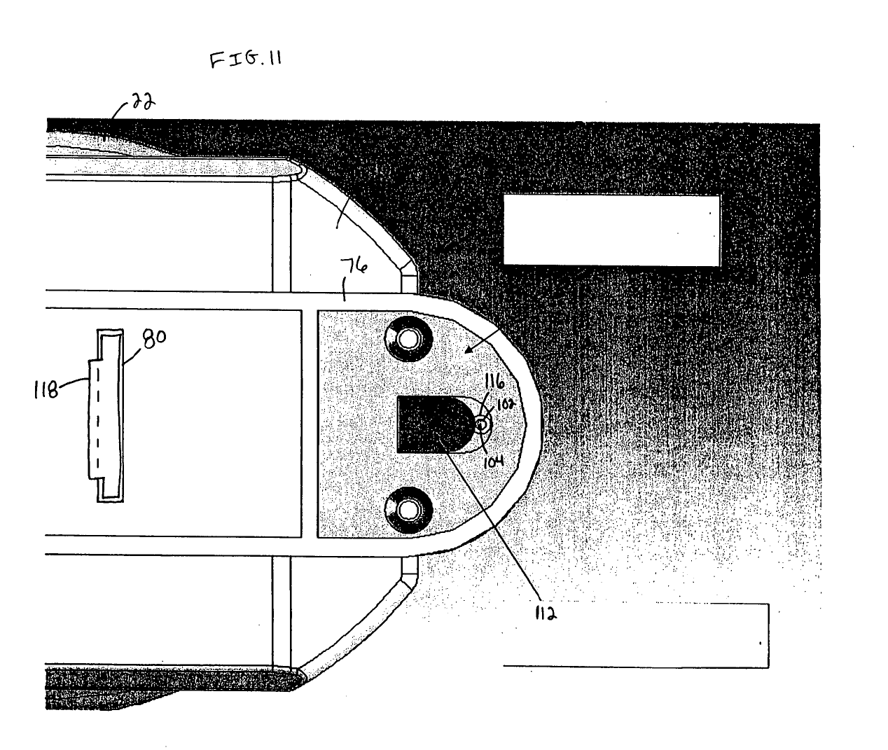

FIG. 11 shows a bottom plan view of the mounting bracket of FIG. 9.

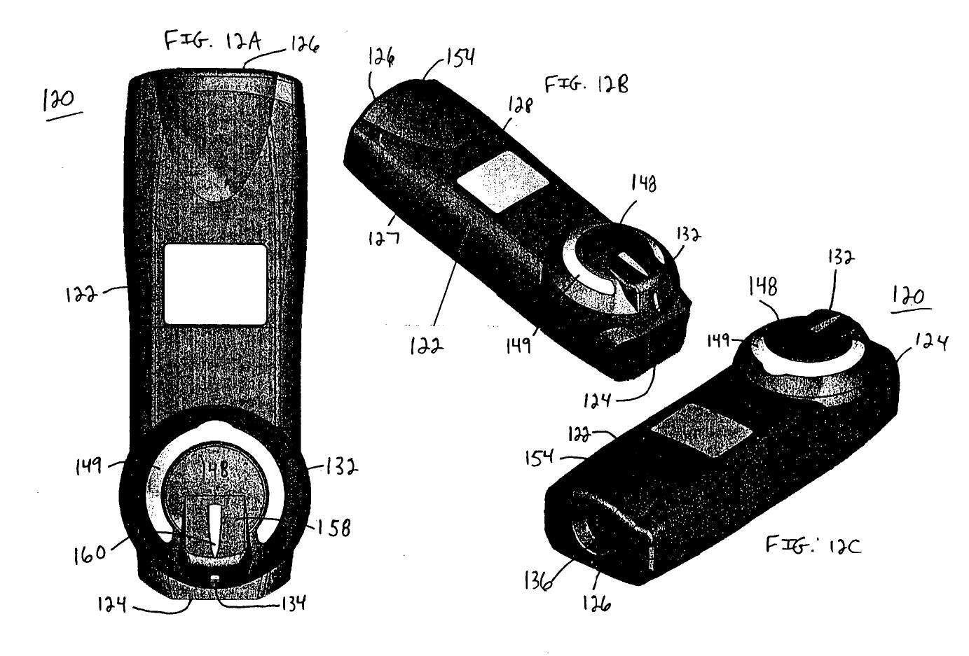

FIGS. 12A-12C show a combination tool, in accordance with other preferred embodiments of the present invention.

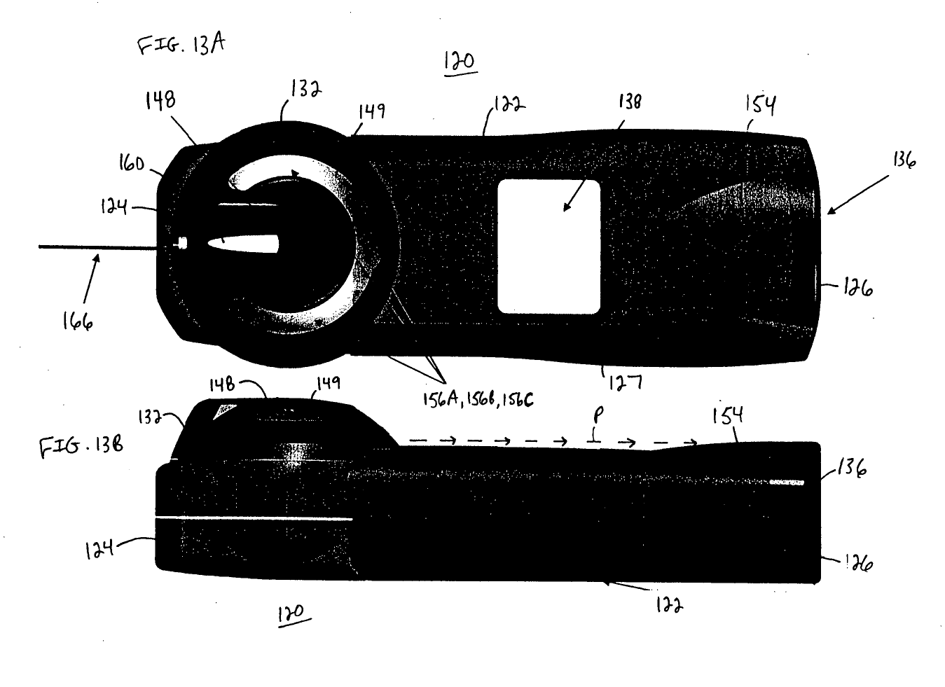

FIG. 13A shows a top plan view of the combination tool of FIGS. 12A-12C.

FIG. 13B shows a front elevational view of the combination tool of FIGS. 12A-12C.

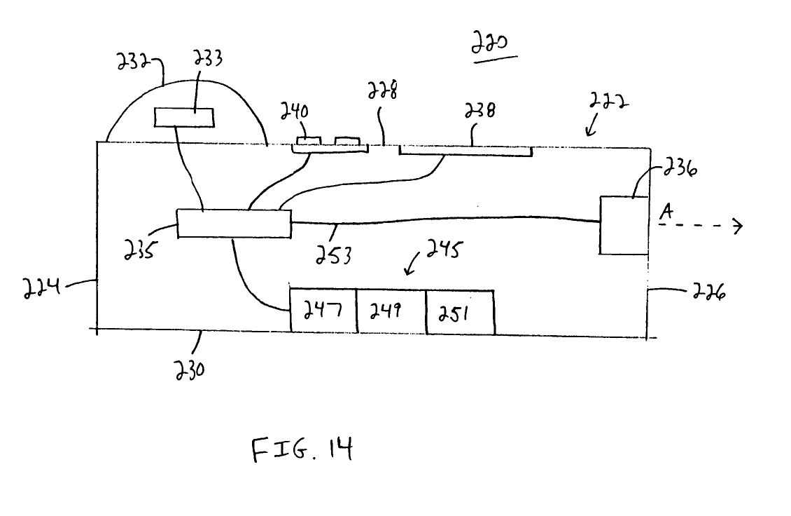

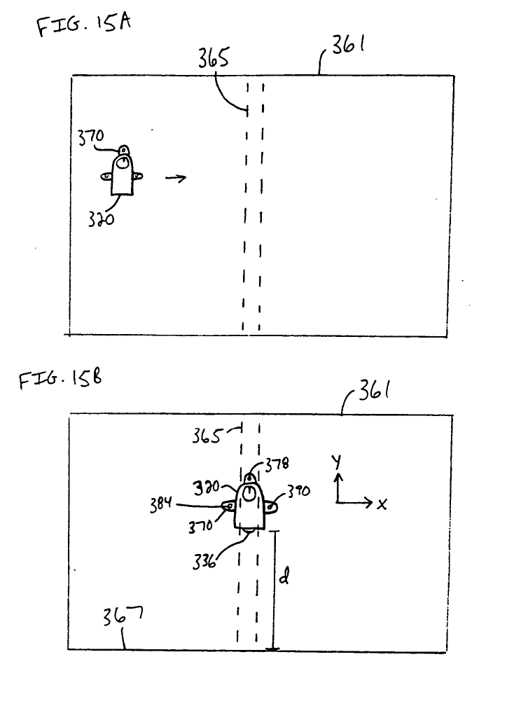

FIG. 14 shows a schematic view of the internal circuitry of a combination tool, in accordance with certain preferred embodiments of the present invention.

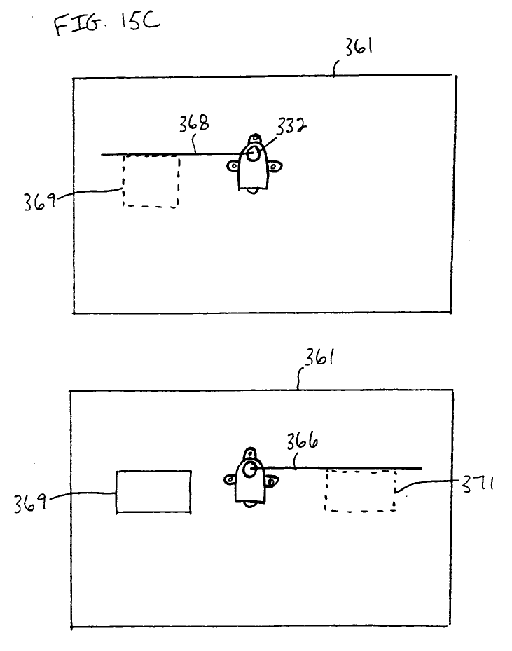

FIGS. 15A-15D show a method of using the combination tool and mounting bracket of FIG. 7 to locate an object hidden behind a wall, in accordance with certain preferred embodiments of the present invention.

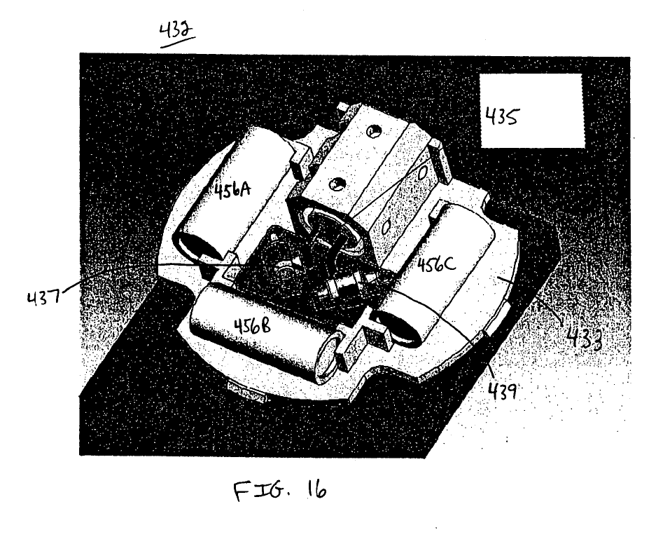

FIG. 16 shows a perspective view of a laser diode subassembly for a combination tool, in accordance with certain preferred embodiments of the present invention.

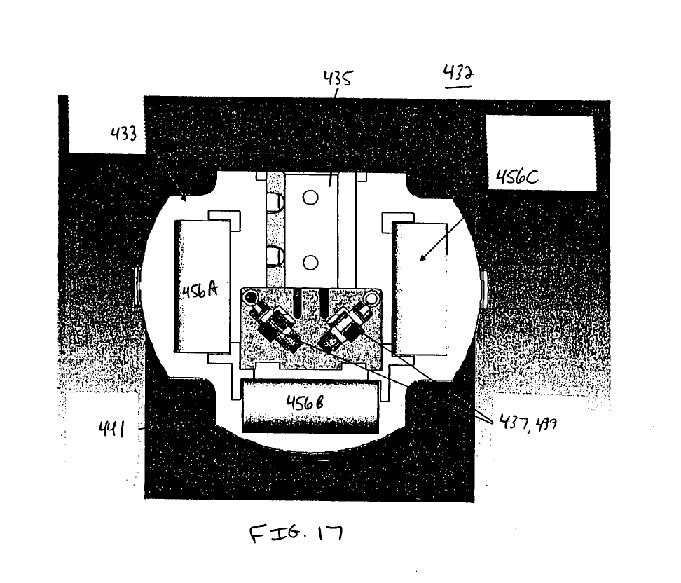

FIG. 17 shows a top plan view of the subassembly shown in FIG. 16.

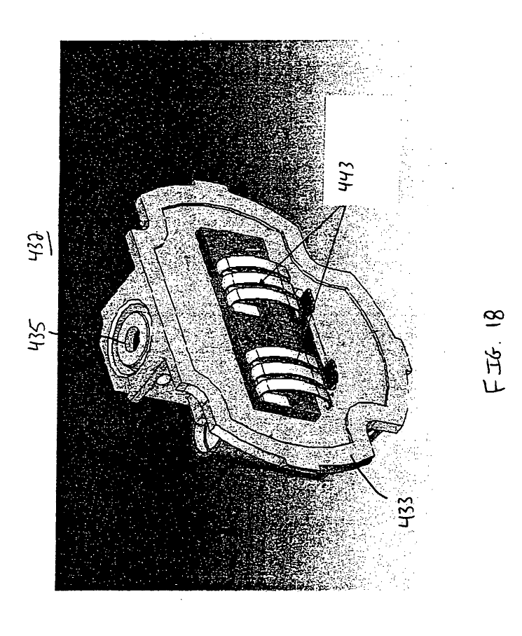

FIG. 18 shows a bottom perspective view of the subassembly shown in FIG. 16.

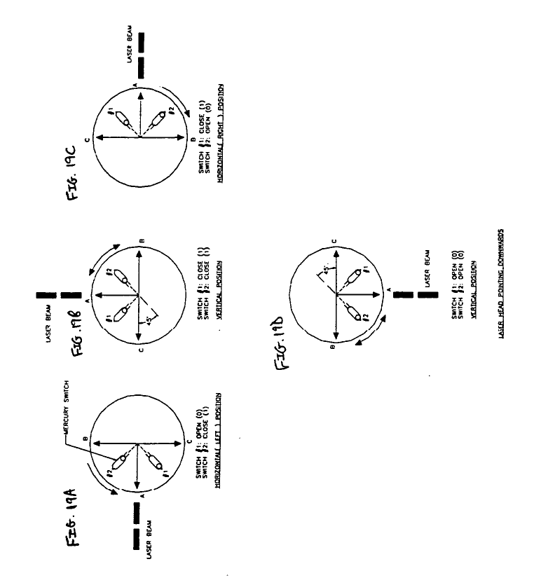

FIGS. 19A-19D show a schematic view of the laser diode subassembly of FIG. 16 at various positions, in accordance with certain preferred embodiments of the present invention.

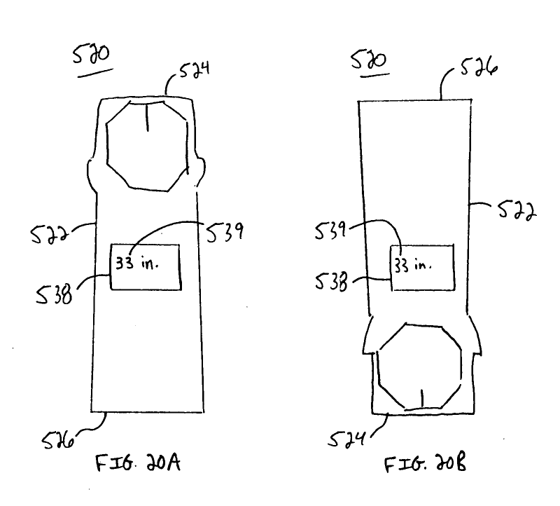

FIG. 20A shows a combination tool in an upright orientation, in accordance with certain preferred embodiments of the present invention.

FIG. 20B shows the combination tool of FIG. 20A in an upside down or inverted orientation.

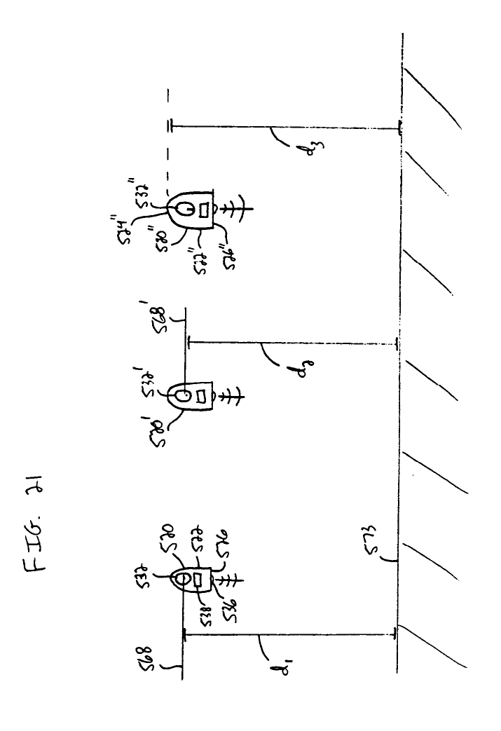

FIG. 21 shows a combination tool having a laser device rotated to different positions, in accordance with certain preferred embodiments of the present invention.

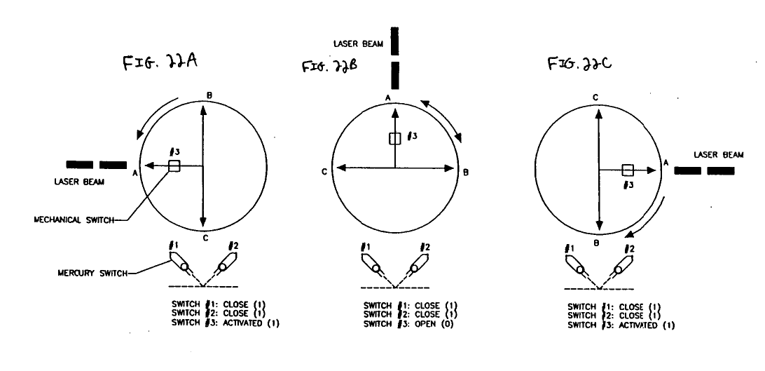

FIGS. 22A-22C show a schematic view of a combination tool having a laser head pointing upwards, in accordance with certain preferred embodiments of the present invention.

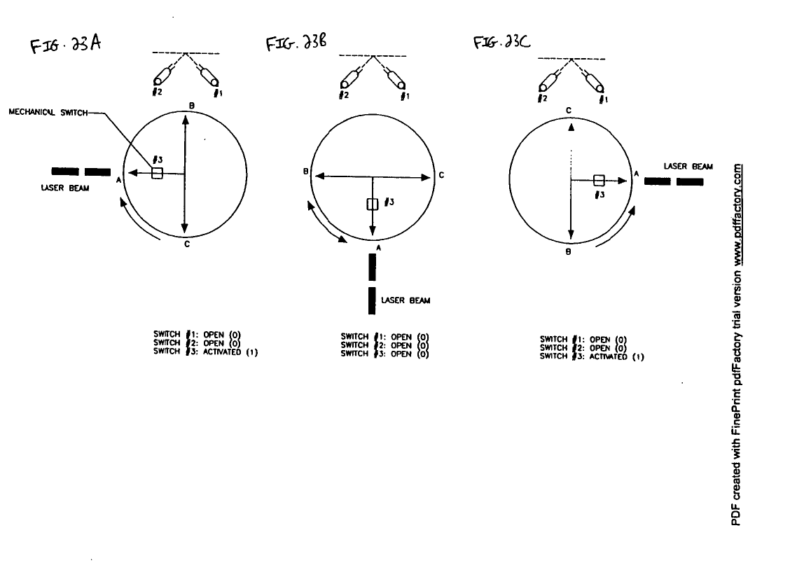

FIGS. 23A-23C show a schematic view of a combination tool having a laser head pointing downwards, in accordance with certain preferred embodiments of the present invention.

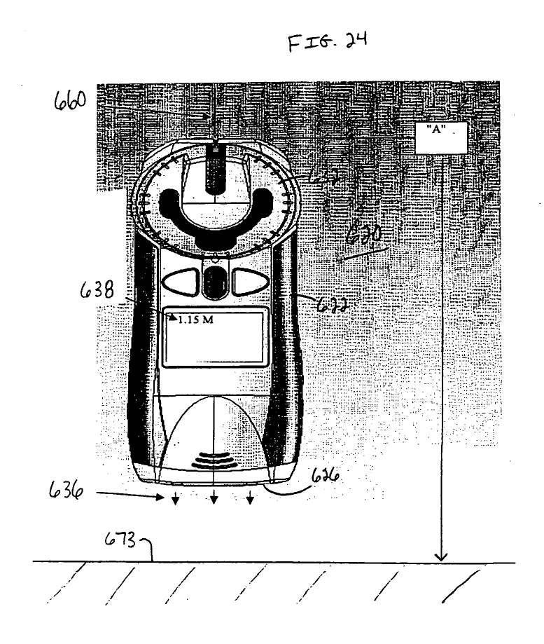

FIG. 24 shows a top plan view of the combination tool shown in FIG. 22B.

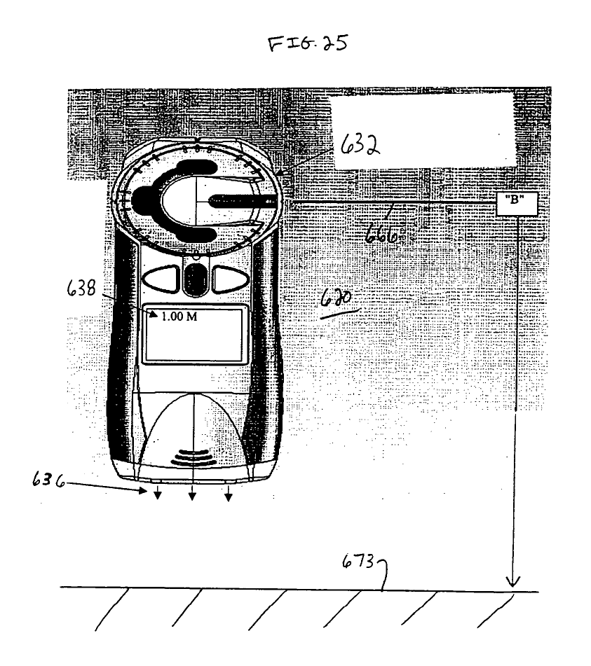

FIG. 25 shows a top plan view of the combination tool shown in FIG. 22C.

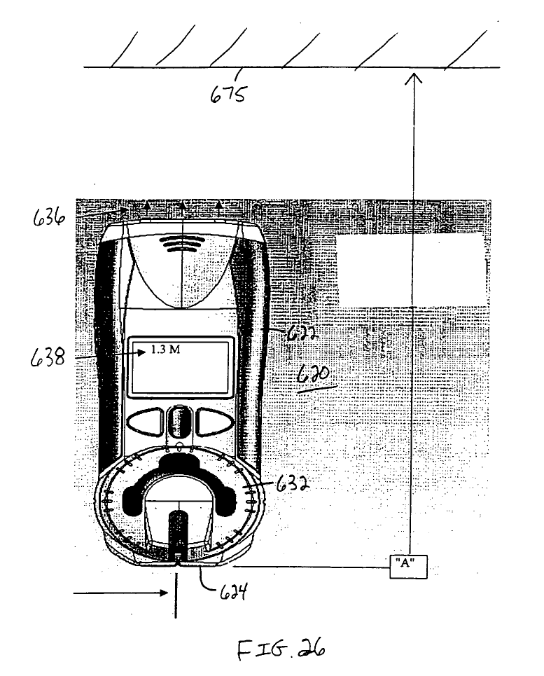

FIG. 26 shows a top plan view of the combination tool shown in FIG. 23B.

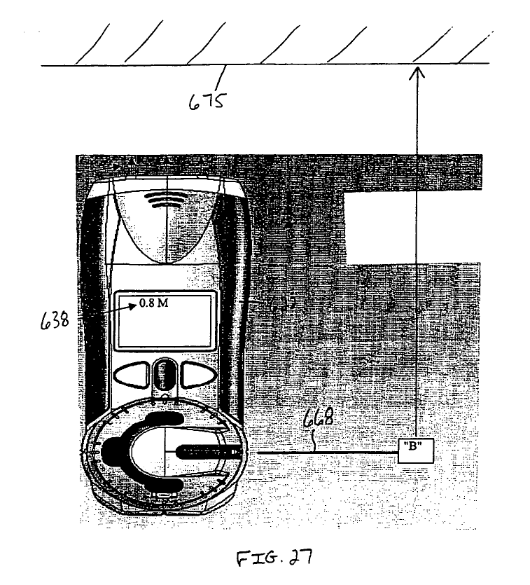

FIG. 27 shows a top plan view of the combination tool shown in FIG. 23C.

FIG. 1 shows a combination tool 20 including a housing 22 having a first end 24 and a second end 26 remote therefrom. The housing 22 also includes a top surface 28 and a bottom surface 30. The top and bottom surfaces 28, 30 extend between the first and second ends 24, 26 of housing 22. The combination tool includes a laser device 32 that is rotatably mounted on housing 22. The laser device includes a laser (not shown) that generates a laser beam. The laser device also preferably includes one or more optical elements 34 that interact with the light beam created by the laser. The optical element may be an optical lens that intercepts the light beam. The optical element may diffract the light beam to generate a laser line on a surface. In other embodiments, the optical element may interact with the light beam to generate a dot of light on a surface.

The combination tool also includes a sonic device 36 provided at the second end 26 of housing 22. The sonic device 36 desirably generates sonic waves for measuring various distances between the housing 22 and a spaced object. The sonic device may measure distances between walls, between a ceiling and a floor or between any two points. The tool may be hung on a wall and the sonic device used to measure a distance between the tool and a ceiling, wall, floor, surface or object. The sonic device may also be used to determine the height of an object above a point, such as the height of a picture frame above the floor.

Housing 22 also includes a visual display 38, such as a LED or LCD display. The visual display may present information such as a distance measured by sonic device 36 or an alignment angle designated by laser device 32. The visual display 38 may also show any information related to the operation of the combination tool 20, such as what type of object is sensed under a surface. In certain preferred embodiments, the orientation of the information presented on the display may change depending upon the orientation of the tool 20. The combination tool 20 also includes control buttons 40A-40E. The control buttons may be depressed and/or manipulated for activating and/or controlling the combination tool 20.

The combination tool 20 also preferably includes one or more sensors for detecting a hidden stud through a structure, an electrical wire through a structure and/or a reinforcement bar through concrete. The combination tool 20 preferably includes a switch 42 for activating the stud/current/rebar sensor (not shown).

Referring to FIG. 2, the housing 22 has a length L extending between first end 24 and second end 26. The housing 22 has a width W extending between first sidewall 44 and second sidewall 46. The rotatable laser device 32 is provided adjacent the first end 24 of housing 22 and the sonic distance measuring device 36 is located adjacent the second end 26 of housing 22. In a particular preferred embodiment shown in FIG. 2, the laser device includes a first optical element 34A, a second optical element 34B and a third optical element 34C. The first optical element 34A is provided at 90° left, the second optical element 34B is provided at 0° and the third optical element 34C is provided at 90° right. The laser device may be rotated 90° to the left for projecting light through the first optical element 34A. The laser device may also be rotated to the position shown in FIG. 2 for projecting light through the second optical element 34B. The laser device may also be rotated 90° to the right to project light through the third optical element 34C. In other preferred embodiments, the optical element may be placed at 90° left, 60° left, 45° left, 30° left, 15° left, 0°, 15° right, 30° right, 45° right, 60° right and 90° right.

The laser device 32 preferably includes a transparent cover 48. As will be described in more detail below, the transparent cover 48 enables leveling vials to be observed therethrough for leveling the combination tool in vertical and horizontal planes. The transparent cover 48 also includes one or more elongated projections 50 formed thereon. The elongated projections 50 preferably facilitate gripping and rotation of the transparent cover 48. In certain preferred embodiments, manipulating and/or depressing one or more of the control buttons 40 may activate the combination tool.

Referring to FIG. 3, combination tool 20 includes housing 22 having first end 24, second end 26 and intermediate region 27 disposed between the first and second ends. Housing includes top surface 28 and bottom surface 30 remote from the top surface 28. Adjacent first end 24, combination tool 20 has a height H₁ extending between the apex 52 of cover 48 and the bottom surface 30 of housing 22. The combination tool 20 includes a second height H₂ in the intermediate region 27 of housing 22. The second height H₂ extends between top surface 28 and bottom surface 30 of housing 22. Housing 22 also includes an upwardly sloping surface 54 extending between intermediate region 27 and second end 26. Laser device 32 includes first optical element 34A that cooperates with light generated by a laser (not shown) to project a laser line or a laser beam. In preferred embodiments, the first optical element 24 diffracts light from the laser to project a laser line onto a surface such as a floor, wall or ceiling.

Referring to FIG. 4, housing 22 includes first end 24 and laser device 32 rotatably mounted on the housing 22. Laser device 22 includes transparent cover 48, which facilitates visual observation of leveling devices 56A-56E through the transparent cover 48. The leveling devices 56A-56E assist a user in leveling the combination tool 20 in horizontal and vertical planes.

Laser device 32 includes a first optical element 34A for projecting a laser line at 90° left, a second optical element 34B for projecting a laser line at 0° and a third optical element 34C for projecting a laser line at 90° to the right. In order to project a laser line at 90° to the left, the head 58 of cover 48 is rotated counterclockwise until pointer 60 is aligned with first optical element 34A. A laser line may be projected at 0° relative to the housing 22 by rotating the head 58 until pointer 60 is aligned with second optical element 34B. The combination tool 20 may project a laser line 90° to the right by rotating the head 58 until pointer 60 is aligned with third optical element 34C. As will be described in more detail below, the laser device may be rotated so that the pointer 60 of head 58 is pointing toward the second end 26 of housing 22. In this position, the light beam emitted by the laser is not diffracted so that it is projected as a dot of light on a surface. In other words, the light beam emitted from the laser is not diffracted to produce a laser line when the head 58 of the laser device 32 is directed toward the second end 26 of housing 22. In this orientation, the combination tool 20 may be used to measure a distance between the first end 24 of the tool 20 and a spaced object. For example, the second end 26 may be directed toward a remote, vertically extending wall. The laser device may be rotated so that the pointer 60 faces the second end 26 of the housing. The laser device will then produce a dot of light on the vertically extending wall. The dot of light indicates the direction of the sonic waves emitted by the sonic device. The sonic device 36 will then emit sonic waves toward the vertically extending wall and internal components of the combination tool 20 will determine the distance between the vertically extending wall and the first end 24 of the housing 22. In another embodiment, the combination tool 20 may be hung on a wall, aligned with features to the left or right of the device by projecting laser lines at 90° left or 90° right, leveled using the bubble levels and then the sonic device may be used to determine a distance between a floor or ceiling and the projected laser line at 90° left or 90° right.

FIG. 5A shows combination tool 20 with laser device 32 being oriented toward first end 24 of housing 22. The laser device 32 generates a laser line 60 projected at 0° relative to a longitudinal axis of housing 22. FIG. 5A also shows sonic distance measuring device 36 emitting sonic waves 62 from the second end 26 of housing 22. The sonic waves 62 are directed along an axis 64 that is preferably parallel to the longitudinal axis Y of the housing 22.

FIG. 5B shows laser device 32 being rotated 90° to the right relative to the first end 24 of housing 22. The laser device 32 generates a laser line 66 that may be projected onto a surface such as a floor or wall. FIG. 5C shows laser device 32 rotated 90° to the left relative to the first end 24 of housing 22 for projecting laser line 68 onto a surface such as a floor or wall.

FIG. 5D shows combination tool 20 having laser device 32 rotated 180° so that the laser is directed toward the second end 26 of housing 22. In this mode, the light generated by the laser device acts an aiming tool to indicate where the direction of the sonic waves 62. As is evident in FIG. 5D, laser device 32 is directed along an axis that is substantially similar to the axis 64 of sonic wave 62. FIG. 5D-1 shows a perspective view of combination tool 20 projecting a dot of light on a wall 61. The laser device 32 is rotated 180° so that it is directed toward the second end 26 of housing 22. The laser device is activated for generating a laser beam that is projected as a dot of light 63 on wall 61. Simultaneously, sonic device (not shown) propagates sonic waves 62 along axis 64. Because the laser beam and the sonic waves share a common axis, the dot of light 63 serves as an aiming point for indicating where the sonic waves 62 are striking wall 61. As a result, a distance d between the wall 61 and the first end 24 of housing 22 can be accurately determined.

FIG. 6 shows a mounting bracket 70 for mounting the combination tool of FIGS. 1-4 on a surface. The mounting bracket 70 includes a top surface 72 and a bottom surface 74 facing away from top surface 72. Mounting bracket 70 has a first leg 76 including a first push pin 78 and a first slot 80. Mounting bracket 70 includes a second leg 82 having a second push pin 84 and a second elongated slot 86. Mounting bracket 70 also includes a third leg 88 having a third push pin 90 and a third elongated slot 92.

In operation, the mounting bracket 70 may be used for positioning the combination tool on a surface, such as a wall or a floor. The elongated slots 80, 86 and 92 are adapted to receive projections extending from the bottom surface of the combination tool so that the tool can be attached to the mounting bracket. The projections preferably snap fit into the elongated slots 80, 86 and 92 for securing the combination tool to the mounting bracket 70. The push pins 78, 84 and 90 are extended for securing the mounting bracket 70 to a surface.

Referring to FIG. 7, mounting bracket 70 is secured to a surface such as a vertically extending wall 96. The push pins 78, 84 and 90 are extended for biting into the wall 96 for securing the mounting bracket 70 to the wall. As the mounting bracket 70 is secured to the wall 96, a user may observe the leveling vials (not shown) through the transparent cover 48 of laser device 32, so as to insure that the combination tool is properly leveled in horizontal plane X and vertical plane Y. The second end 26 of housing 22 is oriented toward the ground (not shown) so that the sonic device 36 can project sonic waves at the ground. As a result, a distance between the ground and the first end 24 of housing 22 may be determined. The distance may be displayed on visual display 38 of combination tool 20.

Referring to FIG. 8, the three legs 76, 82 and 88 of mounting bracket 70 extend beyond the housing 22 so that the push pins 78, 84 and 90 and accessible. As will be described in more detail below, the mounting bracket 70 includes a safety feature that normally covers the pointed ends of the push pins. The safety feature prevents the push pins from being extended until a user takes affirmative steps. Furthermore, the safety feature locks the push pins in an extended position when desired by the user.

The transparent cover 48 of laser device 32 enables an operator to observe the respective leveling devices 56A-56C therethrough. The leveling devices facilitate horizontal and vertical alignment of the combination tool 20.

In a particular preferred embodiment shown in FIG. 8, laser device 32 includes five optical elements 34A′-34E′. The first optical element 34A′ is located at 90° left, the second optical element 34B′ is located at 0° and the third optical element 34C′ is located at 90° right. The laser device 32 also includes a fourth optical element 34D′ located at 45° left and a fifth optical element 34E′ located at 45° right. As a result, the laser device is able to project laser lines at 90° left, 45° left, 0° (toward the first end 24 of housing 22), 45° right and 90° right. The pointer 60 formed in head 58 is transparent so that a user can observe whether the laser (not shown) is operational.

FIG. 9 shows combination tool 20 secured to mounting bracket 70. The first arm 76 of mounting bracket 70 includes push pin 78 having cap portion 98 and pin holder portion 100. The housing 22 is mounted on mounting bracket 70 so that first end 24 of housing 22 faces push pin 78.

FIG. 10 shows a cross-sectional view of the push pin 78 provided in the first leg 76 of mounting bracket 70. The push pin 78 includes cap 98 that is secured atop a pin holding member 100 holding pin 102. Pin 102 includes a first end 104 having a sharp point and a second end 106 adjacent cap 98. The push pin 78 includes a retraction spring 108 that normally holds the push pin 78 in a retracted position. Push pin 78 also includes a safety lock 110 having a slideable safety cover 112 and a safety spring 114 that normally holds the safety cover 112 in a closed position for covering pin opening 116.

FIG. 11 shows a bottom view of the mounting bracket 70 including first arm 76. The underside of first arm 76 includes safety lock feature having a slideable cover 112 that normally covers pin opening 116 which prevents the pointed end 104 of pin 102 from being accidentally extended from the bottom of mounting bracket 70. First arm 76 also includes elongated slot 80 adapted to receive a projection 118 extending from a bottom surface of housing 22. The projection 118 preferably snap fits into the elongated slot 80 for securing the housing 22 to mounting bracket 70.

Referring to FIGS. 12A-12C, in another preferred embodiment of the present invention, a combination tool 120 includes a housing 122 having a first end 124 and a second end 126 remote therefrom. The combination tool 120 includes a laser device 132 rotatably mounted to housing 122 adjacent the first end 124 thereof. The laser device 132 includes a cover 148 having a transparent section 149 provided therein. The transparent section 149 enables a user to visually observe leveling devices (not shown) located underneath the cover 148. The cover 148 also includes a head 158 having a pointer 160 that indicates the direction to which the laser device has been rotated. The pointer 160 is preferably transparent so that a user may observe whether the laser is operational. Laser device 132 also includes an optical element 134 that is optically aligned with the emission end of the laser. In certain preferred embodiments, the optical element diffracts the light beam from the laser to project a laser line onto a surface such as a floor or vertical wall. Unlike the previous embodiment, the optical element 134 rotates with the laser and the cover 148 so that only one optical element is needed for 360° rotation of the laser device.

Referring to FIG. 12B, laser device 132 may be rotated 360° for projecting laser light at any angle relative to a longitudinal axis of the housing 122. The housing includes top surface 128 extending between first end 124 and second end 126 of housing 122. The top surface 128 includes a sloping portion 154 that slopes upwardly between an intermediate region 127 and the second end 126 of housing 128.

Referring to FIG. 12C, the combination tool 120 includes a sonic distance measuring device 136 provided at the second end 126 of housing 122. The sonic distance measuring device 136 projects sonic waves in a direction away from the second end 126 of housing 122. In preferred embodiments, the sonic distance measuring device 136 projects sonic waves in a direction that is substantially parallel to a longitudinal axis of the housing 122 that extends between first end 124 and second end 126. The sonic distance measuring device may be used to measure distance between a distant object, such as a wall, ceiling or floor and a point on the housing 122. In one preferred embodiment, the sonic device may be calibrated to indicate the distance between the first end 124 of housing 122 and the distant object, even when the sonic device 136 is located at the second end 126. In order to aim sonic distance measuring device relative to a distant surface, the laser device 132 is preferably rotated 180° from the orientation shown in FIG. 12C, whereby the laser device projects light toward the second end 126 of housing 122. As the light is projected from laser device 132, the sloping surface 154 of the housing 122 at least partially obstructs the light so that only a dot of light is projected on the distant surface. The dot of light may be used as an aiming tool because the dot of light and the center point of the sonic waves are substantially co-axial.

FIG. 13A shows a top plan view of the combination tool 120 shown in FIGS. 12A-12C. Combination tool 120 includes housing 122 having first end 124, second end 126 and sloping surface 154 formed in top surface 128 of housing 122 between intermediate region 127 and second end 126. The combination tool includes rotatable laser device 132 having a cover 148 with a transparent section 149 that enables a user to observe level devices 156A-156C. As noted above, the level devices enable a user to level the combination tool 120 in horizontal and vertical planes. Cover 148 also desirably includes transparent pointer 160, which shows an operator the direction that the laser is pointed and enables an operator to confirm that the laser is operational. In a particular embodiment shown in FIG. 13A, the laser device is oriented at 0° relative to first end 124 of housing 122 to project laser line 166 onto a surface such as a floor, wall or ceiling.

Referring to FIG. 13B, when the pointer 160 is oriented toward the second end 126 of housing 122, the laser light is directed along a path designated P. The laser light is at least partially obstructed by sloping surface 154. The sloping surface 154 at least partially blocks the laser light so that a beam of light is projected onto a remote surface. The beam of light will appear as a dot of light on the remote surface. The dot of light may be used for aligning the sonic distance measuring device 136 provided at the second end 126 of combination tool 120. The dot of light indicates the direction of the sonic waves generated by the sonic distance measuring device 136. After the sonic waves are emitted, the waves bounce back from the distant surface and are sensed by the sonic device for estimating the distance between the distant surface and the first end 124 of housing 122.

FIG. 14 shows a simplified, schematic view of a combination tool 220, in accordance with certain preferred embodiments of the present invention. The combination tool 220 includes a housing 222 having a first end 224, a second end 226, an upper surface 228 and a bottom surface 230. The combination tool includes a laser device 232 including a laser 233 that selectively projects light, such as a light beam. The combination tool includes a microprocessor 235 having one or more integrated circuits. The combination tool includes sonic distance measuring device 236 provided adjacent to second end 226 of housing 222. The sonic distance measuring device 236 projects sonic waves from the second end 226 in a general direction indicated by axis A. The combination tool 220 also includes sensing device 245, including a first sensor 247 for sensing wood studs, a second sensor 249 for sensing electrical wires and a third sensor 251 for sensing metal in a structure, such as reinforcement bar in concrete. The combination tool 220 also includes a visual display 238 for presenting data related operational use of the tool. The combination tool 220 also includes one or more buttons or keys 240 for activating and operating the tool 220. The elements are interconnected with one another using communication lines 253. In certain preferred embodiments, the communication lines 253 include conductive traces for passing electrical signals between the above-described components.

FIG. 15A show a method of using the combination tool of the present invention, in accordance with certain preferred embodiments of the present invention. FIG. 15A shows wall 361 having a hidden stud 365 underneath an exterior surface of the wall. The combination tool 320 is attached to the mounting bracket 370. After the device for sensing wood studs is activated, the tool and bracket are moved over the wall until an audible or visual signal is generated by the tool for indicating that the tool is over a stud 365.

Referring to FIG. 15B, when the user has confirmed that the tool 320 and bracket 370 are positioned over stud 365, the user observes the level devices to insure that the tool is leveled in the X and Y planes. Once the user has confirmed that the tool is positioned over stud 365 and is leveled in the X and Y planes, the user extends the push pins 378, 384 and 390 for at least temporarily securing the mounting bracket 370 to the wall 361. The user may also activate the sonic device 336 so that the second end of the tool is at a distance d over floor 367.

Referring to FIG. 15C, the user may then activate the laser device 332 to generate a laser level for alignment purposes. In FIG. 15C, the laser level 368 is 90° to the left. The laser level 368 may be used for aligning a picture frame 369 on wall 361. Referring to FIG. 15D, after the first picture frame 369 has been positioned on the wall 361, the laser device may be rotated 180° so that the laser device produces a laser level 366 at 90° right. The laser level 366 can be used for aligning a second picture frame 371 that is at the same height as the first picture frame 369. The laser device may also be used in a similar fashion for locating metal and/or electrical wires behind a wall.

In a first mode of operation, a user operates the tool 220 to detect wood studs under a surface, such as dry-wall. The user would interact and/or manipulate buttons 240 to select activation of the wood stud sensor 247. The bottom surface 230 of the tool 220 is then placed over the dry-wall surface until the tool generates an audible beep or visual symbol. In another mode of operation, the current sensor 249 can be activated for detecting live wires hidden behind a surface such as dry-wall. In yet another mode, the metal sensor 251 can be activated for detecting the presence of metal underneath a surface. In still another preferred embodiment of the present invention, all three sensors can be activated at one time and the visual display can indicate which type of object, i.e. wood, electrical wire, metal, has been detected. The system may also generate a unique audible sound for each particular type of material sensed. For example, a first audible sound can be generated when wood is sensed, and a second audible sound may be generated when an electrical wire is sensed.

FIG. 16 shows a perspective view of a laser device subassembly 432 including a rotatable element 433. Mounted on the rotatable element 433 is a laser diode assembly 435 that is adapted for generating laser light. The rotatable laser device 432 also includes level vials 456a, 456b and 456c for leveling the device in horizontal and vertical planes. The subassembly 432 also includes a first mercury switch 437 and a second mercury switch 439 that are used for sensing the orientation of the combination tool. As will be described in more detail below, depending upon the orientation of the tool, the respective mercury switches 437, 439 will be in either an open or a closed position. This information is sent to internal circuitry for sensing the orientation of the device. In a first upright orientation, the visual display screen will show information in an upright orientation. In a second orientation of the tool, the visual display will show the information in an inverted orientation. As a result, the user of the device may read the visual information presented in an upright orientation regardless of whether the tool is oriented in an upright orientation or an inverted orientation.

Referring to FIG. 17, the laser device subassembly 432 may be mounted atop a printed circuit board 441 including one or more integrated circuits (not shown). The leveling devices 456a, 456b and 456c are mounted atop rotatable platform 433. The device includes mercury switches 437, 439 that are used for determining the upright or inverted orientation of the tool. As will be described in more detail below, the mercury switches may also be used to determine the angle of the laser diode 435 relative to the tool.

FIG. 18 shows laser device subassembly 432 including rotating contacts 443. The rotating contacts 443 enable a reliable electrical interconnection to be maintained between the laser device subassembly 432 and a power source (not shown) as the rotatable platform 433 is oriented at different positions. Thus, the laser device may be rotated 360° or more and still maintain a reliable electrical interconnection.

FIG. 19A shows the laser device oriented 90° to the left at a horizontal left position. In this orientation, a laser beam is directed along a horizontal plane to the left. The first mercury switch number 1 is in an open position and the second mercury switch number 2 is in a closed position. As a result, information is sent to the internal circuitry that any distance measurement displayed on visual display is for the distance measured between the laser beam and an object spaced from the second end of the housing. FIG. 19B shows the laser device positioned in a vertical orientation so that the first mercury switch is closed and the second mercury switch is also closed. This information is also sent to the internal circuitry. FIG. 19C shows the laser device in a horizontal right position or 90° right so that the laser beam is directed in a horizontal plane. In this orientation, the first mercury switch is in a closed position and the second mercury switch is in an open position. This information is also sent to the internal circuitry for calibrating the device. FIG. 19D shows the laser device in a 180° position with the laser head pointing downwards or toward the second end of the housing. In this orientation, the first mercury switch is in an open position and the second mercury switch is an open position. Thus, the switch position of the mercury switches is constantly sent to the internal circuitry of the device so that the internal circuitry may determine the angle or orientation of the rotatably laser device. The mercury switch information may also be used to determine whether the tool is oriented upright or is inverted. This information will be used to alter the orientation of information displayed on the visual display. For example, if the tool is in an upright orientation, the visual display will present the measuring information in an upright orientation. If the tool is inverted so that the first end faces toward the ground, the information presented on the display will be inverted so that a user can easily read the measuring data.

FIGS. 20A and 20B show a combination tool 520 in accordance with another preferred embodiment of the present invention. In FIG. 20A, the combination tool includes a housing 522 having a first end 524 and a second end 526 remote therefrom. The housing is in an upright position so that the first end 524 is above the second end 526. The housing also includes a visual display 538 for displaying measuring data such as distance measurements. The mercury switches (not shown) determine the orientation of the housing 522 and relay the information to the internal circuitry. The internal circuitry thus determines that the data 539 to be displayed on visual display 538 is to be presented in an upright orientation. When the housing 522 is inverted, the first end 524 is below the second end 526. Once again, the mercury switches (not shown) relay information to the internal circuitry that the housing 522 is inverted. Thus, the data 539 presented on visual display 538 is inverted. Although the present invention is not limited by any particular theory of operation, it is believed that modifying or altering the orientation of the data on visual display in response to the orientation of the housing will make it easier for an individual to read the information in the visual display 538. This will prevent an individual from having to turn his or her head upside down in order to read the visual display 538.

FIG. 21 shows combination tool 520 positioned on a wall over floor 573. The laser device 532 produces a laser 568 at 90° left in a horizontal plane. The mercury switches (not shown) relay their open/close status to the internal circuitry so that the device can be properly calibrated for taking measurements. Based upon the angle of the laser 568 (i.e. 90° left), the internal circuitry knows that the distance to be measured D₁ will be between the laser line 568 and floor 573. Sonic measuring device 536 emits a signal toward floor 573 from second end 526 of housing 522. The sonic device 536 then receives the signals when they bounce off of floor 573. The information is relayed to internal circuitry that calculates the distance between laser line 568 and floor 573. The information is presented on visual display 538. The second combination tool 520′ shows laser device 532′ at 90° right. The tool operates substantially the same as described above to measure the distance between laser line 568′ and floor 573. The distance is represented as D₂. The third combination tool 520″ has laser device 532″ directed toward the second end 526″ of housing 522″. At this particular angle for the laser device 532″, the mercury switches relay information to the internal circuitry that the laser is directed toward the second end 526″ of housing 522″. As a result, the internal circuitry recalibrates so that the measured distance will be from the first end 524″ of housing 522″. This distance is represented by the line designated D₃. Thus, the present invention provides operational hardware that will recalibrate the tool based upon the angle of the laser device. The various points on the housing from which the distance is measured will change depending upon the angle of the laser device. At 90° left and 90° right, the distance will be between the laser line generated by the laser device and the floor. When the laser device is at 180° and points toward the second end of the housing, the measured distance will be from the front end of the housing to the floor 573. It is contemplated that various points between the first end 524 and the second end 526 of the housing may be used for the different angle settings of the laser device.

FIGS. 22A-22C show a schematic diagram for a combination tool, in accordance with further preferred embodiments of the present invention. Referring to FIG. 22A, the combination tool includes an element for indicating whether the tool is upright or inverted. In one particular preferred embodiment, the tool has two mercury switches, designated mercury switch #1 and mercury switch #2. The mercury switch #1 and mercury switch #2 are preferably provided on the housing of the combination tool, however, the switches may be provided elsewhere on the tool. In other preferred embodiments, the mercury switches may be provided on the rotatable laser head. The combination tool also includes another switch, such as a mechanical switch designated switch #3, that is designed to indicate the position of the rotatable laser head. The two mercury switches and the mechanical switch are interconnected with the controller for sending information to the controller.

In FIG. 22A, the combination tool is in an upright orientation and the laser head is rotated 90° to the left for projecting a laser line to the left of the tool. In the state shown in FIG. 22A, the mechanical switch #3 is activated to send a signal to the controller that the rotatable head is rotated 90° to the left. The two mercury switches #1 and #2 are in the closed position to indicate that the laser head is in an upright orientation.

Referring to FIG. 22B, the rotatable head is rotated so that the laser beam is projected at 0° relative to the combination tool. In this orientation, the mechanical switch #3 is open for sending a signal to the controller that the laser beam is at 0°. The mercury switches #1 and #2 are in the closed position to indicate that the tool is in an upright orientation.

In FIG. 22C, the laser head is rotated 90° to the right so that the mechanical switch #3 is activated. In addition, the mercury switches #1 and #2 are in the closed position to indicate that the combination tool is in an upright orientation.

FIGS. 23A-23C show a schematic diagram when the combination tool is inverted or upside down, whereby the laser head is closer to the ground than a second end of the tool. Referring to FIG. 23A, the mercury switches #1 and #2 are open to indicate that the tool is inverted or upside down. The laser head is rotated 90° to the right, whereby the mechanical switch #3 is activated. Information regarding the position of the mechanical switch #3 is preferably sent to the controller of the tool.

FIG. 23B shows the rotatable head with the laser at 0°. In this position, the mechanical switch #3 is open and the two mercury switches #1 and #2 are also open to indicate that the combination tool is inverted.

Referring to FIG. 23C, the rotatable laser head is rotated 90° to the left so that the mechanical switch #3 is activated. In addition, the mercury switches #1 and #2 are open to indicate that the combination tool is inverted.

Referring to FIG. 24, the combination tool 620 is positioned in an upright orientation, whereby the laser device 632 is positioned above the second end 626 of the housing 622. The laser device 632 generates a laser line 660 that is at 0° and is pointing upwards. In the position shown in FIGS. 22B and 24, the mercury switches #1 and #2 are closed to indicate that the tool 620 is in an upright orientation. In response to the rotated angle of the laser device 632, the mechanical switch #3 is open to indicate that the laser line is pointed at 0°. When the information regarding the angle of the laser line is forwarded to the controller (not shown), the controller recalibrates the sonic measuring device 636 so that any measurement appearing on display screen 638 reflects a measurement made from the first end 624 of the housing to the floor 673, represented by the letter “A”.

When the laser device 632 is rotated to the position shown in FIGS. 22C and 25, the mechanical switch #3 is activated. As a result, the sonic measuring device 636 is recalibrated so that any distance measurement displayed on display screen 638 is from the laser line 666 to the floor 673, represented by the letter “B”. In addition, the mercury switches #1 and #2 are closed to provide an indication that the combination tool 620 is in an upright orientation, whereby the information displayed on the display screen 638 is displayed in an upright orientation.

The tool shown in FIGS. 26 and 27 is associated with drawing FIGS. 23A-23C, wherein the combination tool 620 is inverted. FIG. 26 is associated with FIG. 23B, having laser device 632 rotated at 0° so that mechanical switch #3 is open. In addition, because the combination tool 620 is inverted, the mercury switches #1 and #2 are open. With the laser device 632 rotated at 0°, the measurements taken by the sonic measuring device 636 are between the first end 624 of the housing 622 and the ceiling 675, designated by the letter “A”. The information presented on the display screen 638 is inverted for easy reading by a user. If the information were not inverted, a user may have to turn his or her head upside down in order to read the visual display 638. Thus, the present invention changes the orientation of the information shown on the visual display 638 based upon the upright or inverted orientation of the combination tool 620.

FIG. 27 shows an inverted combination tool 620 with the laser device 632 rotated in the position shown in FIG. 23C. In this position, the combination tool 620 measures the distance from the laser line 668 to the ceiling 675, designated by the letter “B”. In addition, because the mercury switches #1 and #2 are open, the information displayed on visual display screen 638 is inverted relative to the housing 622.

In preferred embodiments where one of the mercury switches is open and one of the mercury switches is closed, the information displayed on the visual display may be upright. In other preferred embodiments, the information may be inverted on the visual display when one mercury switch is open and one mercury switch is closed.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A combination tool comprising:
a housing having a first end and a second end;
a laser device rotatably mounted to said housing, wherein said laser device is rotatable to a first position for projecting a laser line and a second position for projecting a laser beam on a surface; and
a sonic device connected to said housing and being adapted to project signals for measuring distances between said tool and a spaced object.

2. The tool as claimed in claim 1, further comprising a microprocessor in communication with said laser device and said sonic device, wherein said microprocessor determines a first distance between said laser line and said surface when said laser device is in the first position and a second distance between a predetermined point on said housing and said surface when said laser device is in the second position.

3. The tool as claimed in claim 2, wherein the predetermined point is the first end of said housing.

4. The tool as claimed in claim 2, further comprising an orientation element in communication with said microprocessor for determining whether the first end of said housing is above the second end of said housing in an upright orientation or the first end of said housing is below the second end of said housing in an inverted orientation.

5. The tool as claimed in claim 4, wherein said orientation element comprises a pair of mercury switches.

6. The tool as claimed in claim 4, further comprising a visual display in communication with said microprocessor, wherein said visual display presents data in a first direction when said housing is in the upright orientation and in a second direction when said housing is in the inverted orientation.

7. The tool as claimed in anyone of claims 1 to 6, further comprising a bracket attached to said housing for supporting said tool over a surface, said bracket having a first mode in which said housing is free to move over the surface and a second mode in which said housing is secured in place over the surface.

8. The tool as claimed in claim 7, wherein said bracket has at least one anchoring element movable between a retracted position for enabling said housing to freely move over the surface and an extended position for securing said bracket to the surface.

9. The tool as claimed in claim 8, wherein said at least one anchoring element includes a pin having a pointed end adapted to engage the surface when said at least one anchoring element is in the extended position.

10. The tool as claimed in anyone of claims 1 to 9, wherein said laser beam projected from said laser device when said laser device is at the second position and said signal projected from said sonic device extend in directions that are substantially co-axial.

11. The tool as claimed in anyone of claims 1 to 10, wherein said laser device includes a laser and at lease one optical element for diffracting light from said laser for projecting said laser line.

12. The tool as claimed in claim 11, wherein said laser is optically coupled with the said optical element when said laser device is rotated to the first position.

13. The tool as claimed in claim 12, wherein said optical element is selected from the group consisting of a lens, a diffraction grating and a holographic element.

14. The tool as claimed in anyone of claims 1 to 13, further comprising a sensor coupled with said housing for detecting objects hidden behind a surface.

15. The tool as claimed in claim 14, wherein said sensor is selected from the group consisting of an electrical current sensing circuitry for detecting electrical wires, a metal sensing circuitry for sensing metal objects and a wood sensing circuit for sensing wood objects.

16. The tool as claimed in claim 15, further comprising:
one or more control buttons accessible at an outer surface of said housing for controlling operation of said tool;
a visual display provided on said housing for displaying measuring, aligning or sensing data.

17. The tool as claimed in anyone of claims 1 to 16, further comprising a first leveling device for leveling said tool in a horizontal plane and a second leveling device for leveling said tool in a vertical plane.

18. The tool as claimed in claim 17, wherein said laser device includes a rotatable cover having a transparent portion and wherein said first and second leveling devices are visible through the transparent portion.

19. The tool as claimed in anyone of claims 1 to 18, wherein said sonic device is provided at the second end of said housing.

20. The tool as claimed in anyone of claims 1 to 19, wherein said housing has a longitudinal axis and said laser device is rotatable for projecting a plurality of laser lines at various angles relative to the longitudinal axis.

21. The tool as claimed in claim 19, wherein said laser device is oriented toward the second end of said housing when in the second rotated position for aiming said sonic device.

22. The tool as claimed in anyone of claims 1 to 21, further comprising at least one leveling device coupled with said housing for leveling said housing in horizontal and vertical planes.

23. The tool as claimed in anyone of claims 7 to 9, wherein said housing is releasably attachable to said bracket.

24. The tool as claimed in claim 23, wherein said bracket has one or more slots and said housing has one or more projections that are adapted to be snap-fit into the one or more slots.

25. The tool as claimed in anyone of claims 1 to 24, wherein said laser device includes a laser adapted to project light and at least one optical element for diffracting light from said laser for projecting said laser line.

26. The tool as claimed in claim 25, wherein said laser and said optical element are optically coupled in the first rotated position and optically uncoupled in the second rotated position.

27. The tool as claimed in anyone of claims 1 to 26, further comprising:
a visual display for presenting information related to operation of said tool;
one or more keys for operating said tool; and
a microprocessor coupled with said sonic device, said visual display and said keys for controlling said tool.

28. The tool as claimed in anyone of claims 8 to 27, wherein said bracket has a safety cover slidable between a closed position when said at least one anchoring element is retracted and an open position when said at least one anchoring element is extended.
